(19) United States
(12) Patent Application Publication
(10) Pub. No.: US 2003/0084829 A1
(43) Pub. Date: May 8, 2003

(54) In-line sub-surface seeding, fertilizing and watering system

(76) Inventor: Noel D. Lempriere, Barriere (CA)

Correspondence Address: REIDLAW, L.L.C., 1926 SOUTH VALLEYVIEW LANE, SPOKANE, WA, 99212-0157, US

(21) Appl. No.: 10/151,341

(22) Filed: May 20, 2002

Related U.S. Application Data
(63) Continuation-in-part of application No. 09/959,682, filed on Nov. 5, 2001, now Pat. No. 6,408,772.

(51) Int. Cl. A01C 5/00

(52) U.S. Cl. 111/50

(57) ABSTRACT

An in-line sub-surface seeding, fertilizing and watering system includes a blade mountable into a header of a parallelogram linkage. A pair of parallel rigid drag arms extend between the header and a hanger assembly and are pinned at their respective ends so that rotation of the header relative to the hanger assembly on the parallel arms maintains a general horizontal orientation of the header thereby supporting the blade downwardly in a constant orientation. The hanger assembly is mountable to a supporting frame. A selective actuator allows selective control of a downward force urging the blade into the soil. An in-line counter wheel is mounted ahead of and in-line with the blade so as to be substantially co-planar therewith. The trailing edge of the counter-wheel is adjacent to the leading edge of the blade.

### CROSS REFERENCE TO RELATED APPLICATION

This application is a Continuation-In-Part from U.S. patent application Ser. No. 09/959,682 entitled In-Line Sub-Surface Seeding, Fertilizing and Watering System.

### FIELD OF THE INVENTION

This invention relates to the field of no-tillage opening blades which may be partially submerged into earth, for example in a farmers field, so as to pass the blade at a submerged depth for delivery of seeds, fertilizer or water into the earth, and to the mechanical system for actuating same.

### BACKGROUND OF THE INVENTION

This invention relates to blade delivery systems which have replaced tillage plows and the like. It is known that the use of plows or other devices having for example tillage discs for tilting the earth or otherwise opening and turning a furrow through the ground suffer from the disadvantage that the moisture in the soil is unnecessarily exposed to evaporation. In the past it was necessary to open the earth so that the ground beneath the surface could be seeded, fertilized and watered. Whether this was accomplished by machinery or done manually, prior art machines or manual systems also suffered from the disadvantage that fertilizer was typically delivered into close proximity to the seeds being sown occasionally resulting in the seeds becoming chemically burnt.

Thus there exists a need for, and it is an object of the present invention to provide, a blade and actuating system wherein the blade may be partially submerged into earth and translated therethrough, where the blade disturbs the earth minimally and without tillage and is adapted to deliver one or all of seeds, fertilizer or water from the blade in advantageous spaced apart relation as hereinafter described.

### SUMMARY OF THE INVENTION

The sub-surface seeding, fertilizing and watering system of the present invention includes a mechanical actuating parallelogram linkage for actuating an opening blade. The blade has first and second sides extending between a leading edge and an aft edge. The first and second sides are advantageously generally symmetrical to each other on either side of a first plane, where the first plane generally bisects the opening blade, and the leading edge and the aft edge lie generally in the first plane.

The opening blade has an upper surface and a lower surface extending between upper and lower edges respectively of the first and second sides of the blade. First and second wings are mounted to the first and second sides respectively in generally oppositely disposed relation so as to be cantilevered outwardly therefrom. The first and second wings extend between first and second forward wing edges and first and second aft-opening wing apertures in the first and second wings respectively. The first and second wings are mounted to the first and second sides at, respectively, first and second distances from the lower surface measured generally parallel to the first plane. First and second canards may be mounted to the tip of the blade ahead of the wings, the canards similarly disposed so as to extend oppositely generally horizontally from the sides of the blade.

The opening blade has therethrough, and generally lying in the first plane, first and second conduits, extending from, and cooperating with, at uppermost ends thereof, first and second infeed ports in the upper surface. The first and second conduits cooperate with, at lowermost ends thereof, first and second wing ducts extending aft through the first and second wings respectively between the lowermost ends of the first and second conduits and the first and second aft opening wing apertures. The first and second conduits and the corresponding first and second wing ducts are thereby in material flow communication between the first and second infeed ports and the corresponding first and second aft opening wing apertures for seed, fertilizer or fluid flow, as fed from a material feeder, therethrough during the forward translation of the blade.

The opening blade is mountable to the actuating linkage so as to be generally vertically disposed, when mounted thereon, for partial submerging into soil to a first submerged depth advancing the leading edge through the soil. The first and second distances are less than the first submerged depth so that the first and second wings are submerged in the soil during the forward translation of the blade.

In one preferred embodiment, the opening blade further includes a third conduit extending in material flow communication between a third infeed port in the upper surface and an aft opening blade aperture in a rearward position on the opening blade in proximity to the aft edge for seed, fertilizer or fluid flow therethrough, as fed from the material feeder. Advantageously, the aft-opening blade aperture is centrally disposed relative to the first plane so as to lie generally symmetrically across the first plane, and may be positioned so that the aperture intersects the lower surface of the blade. Thus the aft-opening blade aperture is formed at the intersection of the lower surface and the aft edge of the blade. The aft-opening blade aperture may lie in a second plane at generally 30° inclined relative to a third plane generally containing the lower surface of the blade, wherein the third plane is generally orthogonal to the first plane.

Advantageously, the first, second and third conduits are generally parallel and raked aft of their corresponding first, second and third infeed ports. The first, second and third conduits may be raked aft at an angle of approximately 55° relative to a fourth plane generally containing the upper surface of the blade if the upper surface is a planar generally horizontal surface, although this is not necessarily so.

In one embodiment, but not so as to be limiting, at least the first and second conduits are formed by mating of corresponding opposed facing channels in oppositely mounted side panels, oppositely mounted in, or mountable into, first and second sides of the blade.

In a further aspect of the design, the third conduit is generally parallel and adjacent the aft edge and the leading edge is concavely curved so as to substantially follow the curvature of an in-line coulter wheel mounted ahead of and adjacent the leading edge of the blade, the leading edge forming a pointed toe at the intersection of the leading edge and the lower surface of the blade a fist distance from the coulter wheel. Advantageously, the pointed toe may be made of hardened material relative to the hardness of material forming the balance of the opening blade. The coulter wheel and leading edge form an opening at the toe of the blade which is sufficiently narrow to prevent large rocks or boulders becoming jammed therebetween.

In a further aspect, the opening blade may be defined as having a longitudinal length dimension and a height dimension, where the longitudinal length dimension is perpendicular to the height dimension and both dimensions lie in the first plane. Further, the opening blade has a lateral width dimension perpendicular to the first plane.

The longitudinal length dimension extends between the leading and aft edges often blade, the height dimension extends between the upper and lower surfaces of the blade, and the lateral width dimension extends between the first and second sides of the blade. In the present design, the length dimension is much, that is, significantly greater than the width dimension, as described hereinafter. The height dimension in one embodiment is greater than the submerged depth so that the blade is supported above the soil and the blade thus partially submerged during forward translation, although this is not intended to be limiting. That is, it is readily conceivable to mount the blade to a support that itself becomes partially submerged in the soil.

Further advantageously, the first and second wings are wedge-shaped and the forward wing edges are vertices of the wedge-shaped wings.

The sides of the blade may be thought of as having upper and lower portions respectively above and below the wings. Thus, the first and second sides have upper portions generally located, respectively, between the first and second wings and the upper surface of the blade, and lower portions generally located between, respectively, the first and second wines and the lower surface of the blade. The lower portions collectively form a waisted or foot shape so that a forward width dimension of a forward flared portion of the lower portion of the opening bade and an aft width dimension of an aft flared portion of the lower portion of the opening blade, the forward and aft width dimensions extending between the lower portions of the first and second sides, are greater than an intermediate width dimension of a waisted portion longitudinally extending contiguously between the forward and aft flared portions.

The first wing may be defined as being set back a first longitudinal distance from the leading edge and the second wing as being set back a second longitudinal distance from the leading edge. Thus, in one aspect of this design, the first longitudinal distance may be greater than the second longitudinal distance. Correspondingly, the first wing mounted to the fist side of the blade at a first longitudinal location generally corresponding to the aft flared portion of the blade and the second wing may be mounted to the second side at a second longitudinal location generally corresponding to the waisted portion of the blade.

In the wing design, an upper wing surface on the first and second wings extends aft over the corresponding first and second aft-opening wing apertures on aft cantilevered upper wing members. The lower ring surface on the first and second wings may form a first wedge angle of approximately 5° with the upper wing surface. Further, laterally outer-most wing surfaces extend between the upper ad lower wing surfaces. The laterally outer-most wing surfaces may advantageously intersect the corresponding first and second sides of the blade at their corresponding first and second forward wing edges. Thus the laterally outer-most wing surfaces may form a second wedge angle of approximately 5° relative to the first and second sides of the blade respectively. Advantageously, the first and second wings may themselves also be inclined downwardly so that a pair of corresponding planes bisecting the wedge angle between the upper and lower wing surfaces on each of the first and second wings, where the pair of corresponding planes contain the corresponding forward wing edges, are inclined forwardly and downwardly at approximately 5° relative to a generally horizontal plane containing the lower surface, it being taken for the sake of this defied relationship that the lower surface is generally planar and horizontal, although this is not intended to be limiting, and is not necessarily so, notwithstanding that the preferred embodiment hereinafter described is illustrated as such.

The blade is mountable into a header of the parallelogram linkage. A pair of parallel rigid drag alms extend between the header and a hanger assembly and are pinned at their respective ends so that rotation of the header relative to the hanger assembly on the parallel arms maintains a general horizontal orientation of the header thereby supporting the blade downwardly in a constant orientation. The hanger assembly is mountable to a supporting frame. An array of such assemblies supporting an array of linkages, coulter wheels and blades may be mounted across the supporting frame. Selective actuation means such as a hydraulic actuator allows selective control of a downward force urging the blade into the soil. Where the selective actuation means is a hydraulic actuator mounted between the hanger assembly or frame and the parallel drag arms or header, the actuating linkage may be selectively elevated so as to remove the coulter wheel and blade from the soil.

The coulter wheel may be mounted to a forward end of the header, ahead of the leading edge of the blade. In a further alternative embodiment, a furrow closing means such as a closing wheel or plurality, such as canted pair, of closing wheels are mounted to a rear end of the header so as to trail rearwardly therefrom in line with a furrow created by the blade passing through the soil. The closing means may be urged downwardly by a selectively adjustable downward biasing means such as a pivotally mounted rocker arm pivotally mounted to a rear end of the header and selectively adjustable so as to be rotated downwardly to downwardly bias the furrow closing wheel.

### BRIEF DESCRIPTION OF THE DRAWING

FIG. 1 is, in exploded perspective view, the inline, subsurface seeding, fertilizing and watering blade of the system of the present invention.

FIG. 2 is a cross-sectional view along line 2-2 in FIG. 1.

FIG. 3 is, in left side elevation view, the device of FIG. 1.

FIG. 3a is, in left side elevation view, an alternative embodiment of the blade of FIG. 3.

FIG. 3b is, in left side elevation view, a further alternative embodiment of the blade of FIG. 3.

FIG. 4 is, in bottom perspective view, the device of FIG. 1.

FIG. 5 is, in rear elevation view, the device of FIG. 1.

FIG. 6 is the view of FIG. 5 as the blade is passed through soil.

FIG. 7 is the rear elevation view of FIG. 6 with the blade removed for clarity so as to illustrate an approximation of the soil mechanics during an initial seed placing and fertilizing phase.

FIG. 8 follows on as a time-elapsed view of the view of FIG. 7, illustrating the collapse of the soil and lateral translation of the seeds following the initial phase.

FIG. 9 is, in a generally side perspective view, the actuating linkage of the in-line sub-surface seeding, fertilizing and watering system of the present invention, with the actuating linkage in a lowered position.

FIG. 10 is, in a rear and lower perspective view, the actuating linkage of FIG. 9.

FIG. 11 is, in a rear and side perspective view, the actuating linkage of FIG. 9.

FIG. 12 is the linkage of FIG. 9 showing the coulter wheel and blade lowered into the soil.

FIG. 13 is, in perspective view partially cut-away, a system of arrays of the actuating linkage, coulter wheel and blade of FIG. 9 mounted in lateral arrays on a wheeled supporting frame.

FIG. 14 is, in side elevation view, the system of FIG. 13.

FIG. 15 is the view of FIG. 9, with the actuating linkage elevated to pass over a boulder.

### DETAILED DESCRIPTION OF EMBODIMENTS OF THE INVENTION

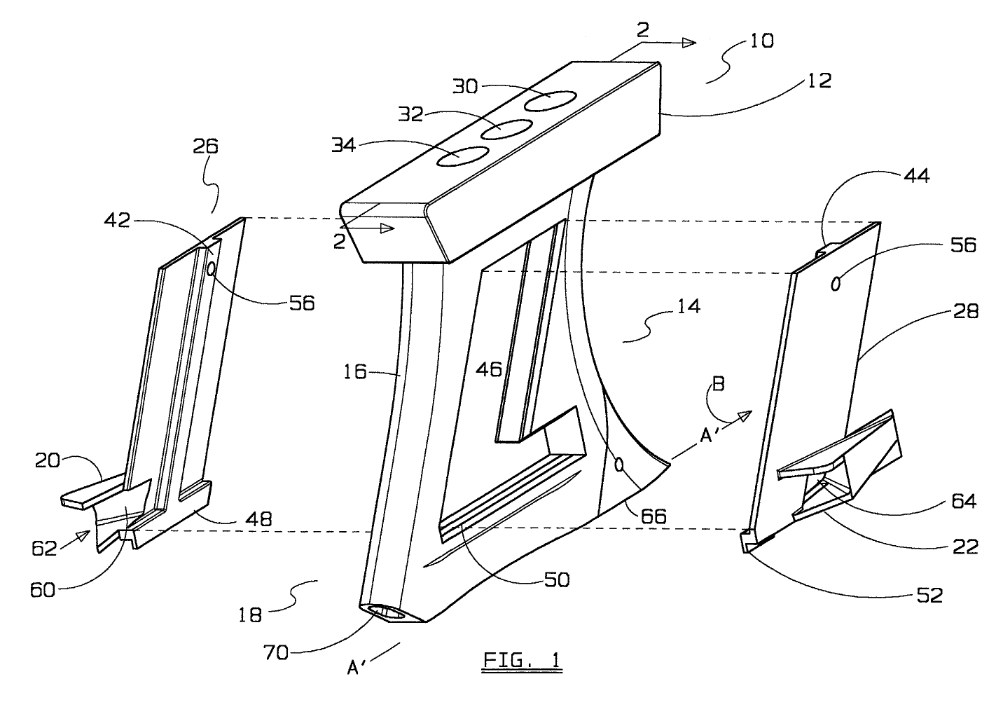

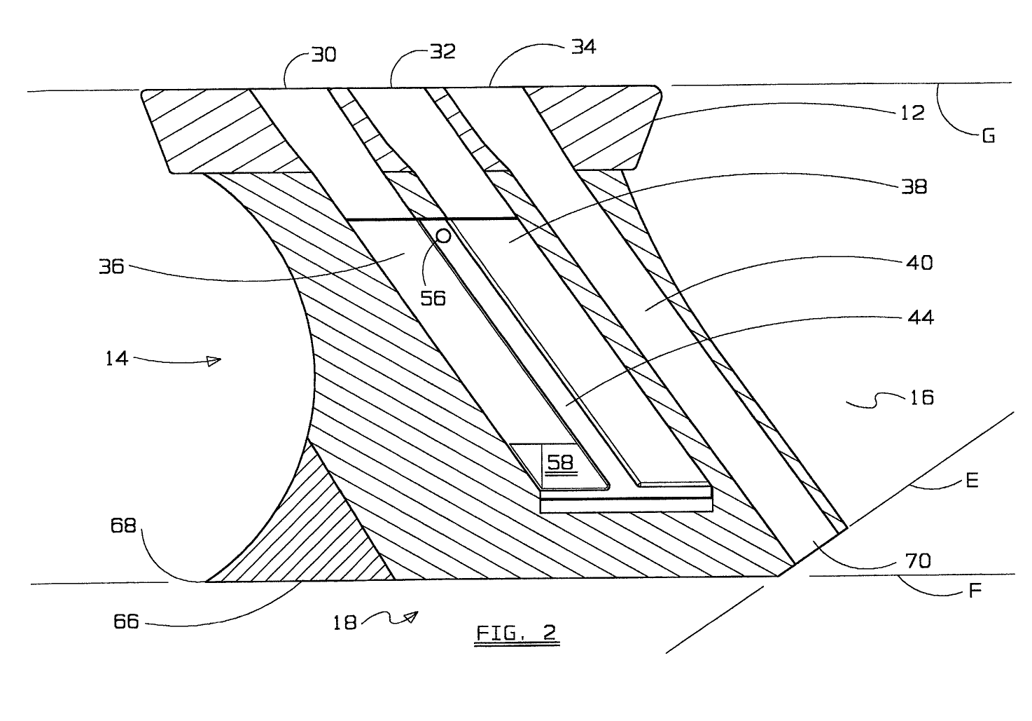

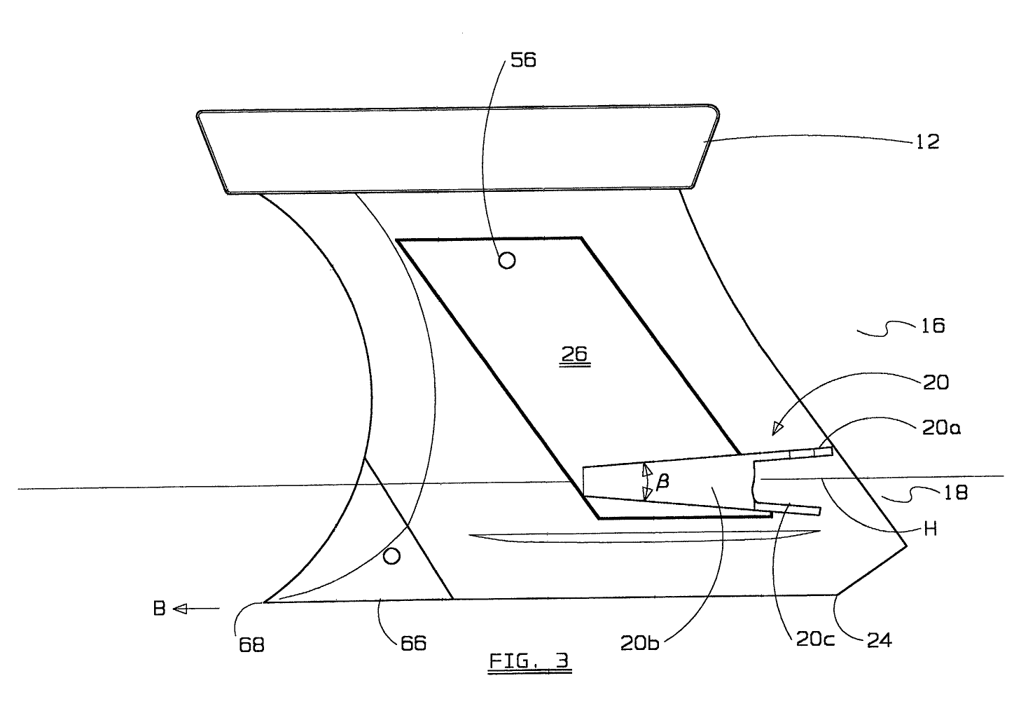

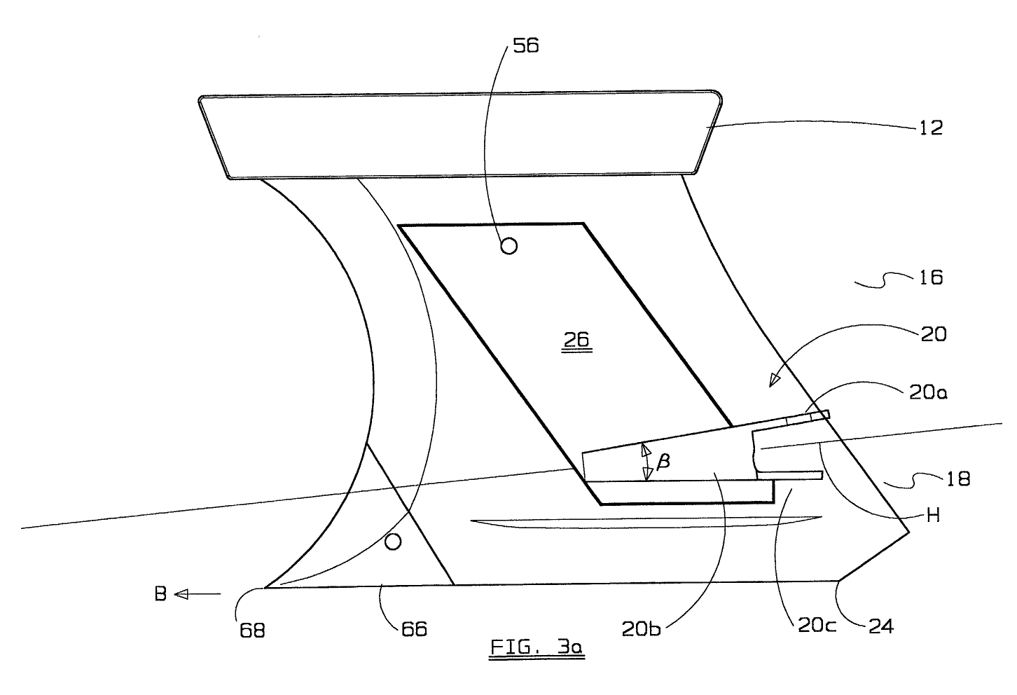

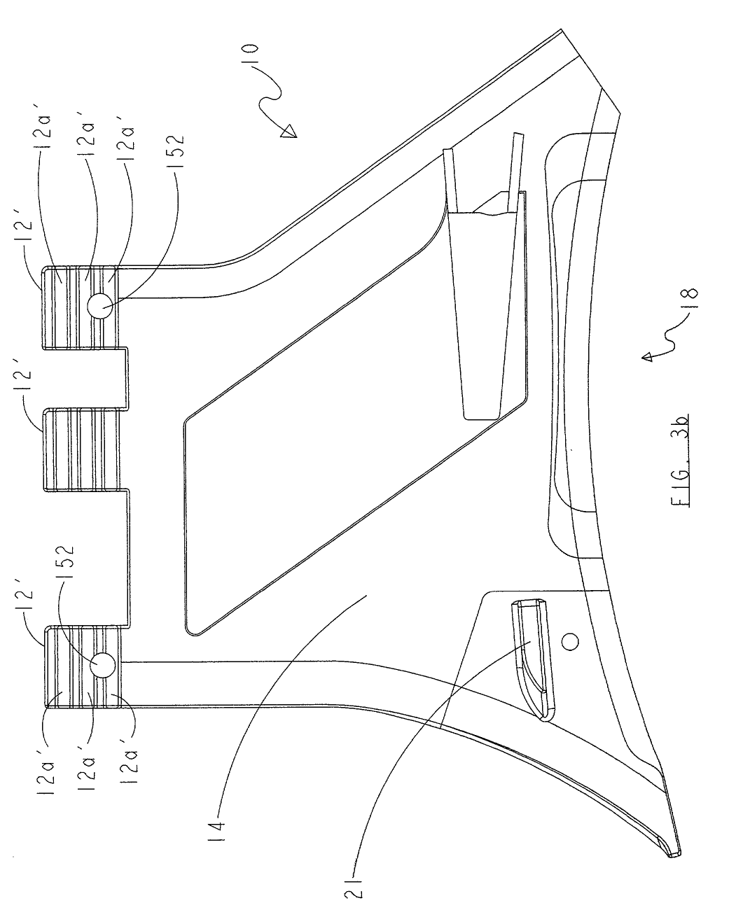

As may be seen by way of example in FIG. 1, the no-tillage in-line sub-surface seeding, fertilizing and watering blade of the system of the present invention is depicted as opening blade 10. Opening blade 10 has an upper, ported, mounting block 12, or, in the embodiment of FIG. 3b, mounting ears 12′, rigidly mounted atop a generally planar blade structure 14. Blade structure 14 has a trunk 16 depending generally vertically beneath the upper ported mounting base or block 12 or ears 12′. Formed as pan of the lower end of trunk 16 is a foot structure generally indicated by numeral 18.

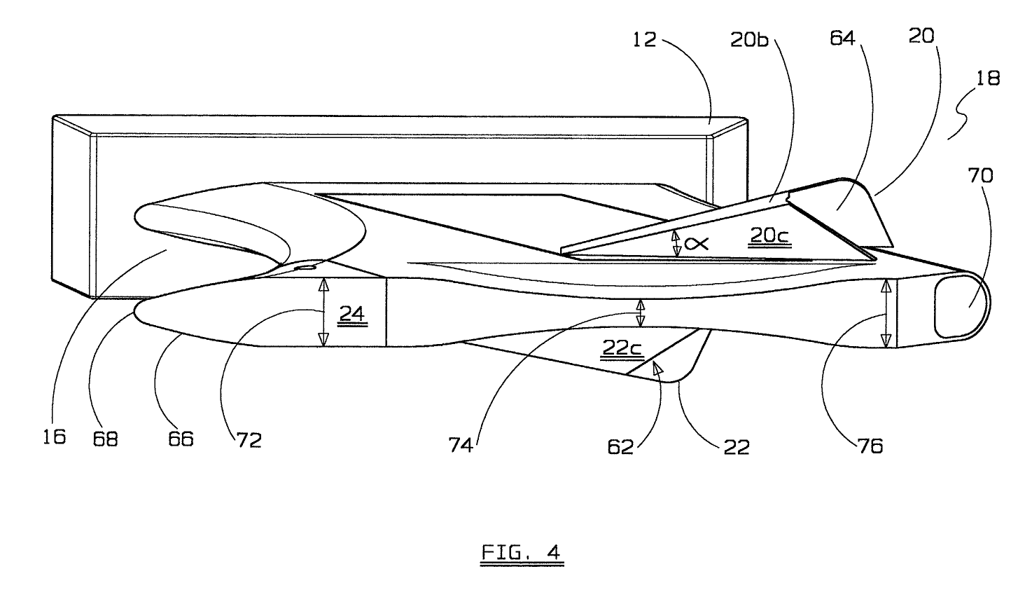

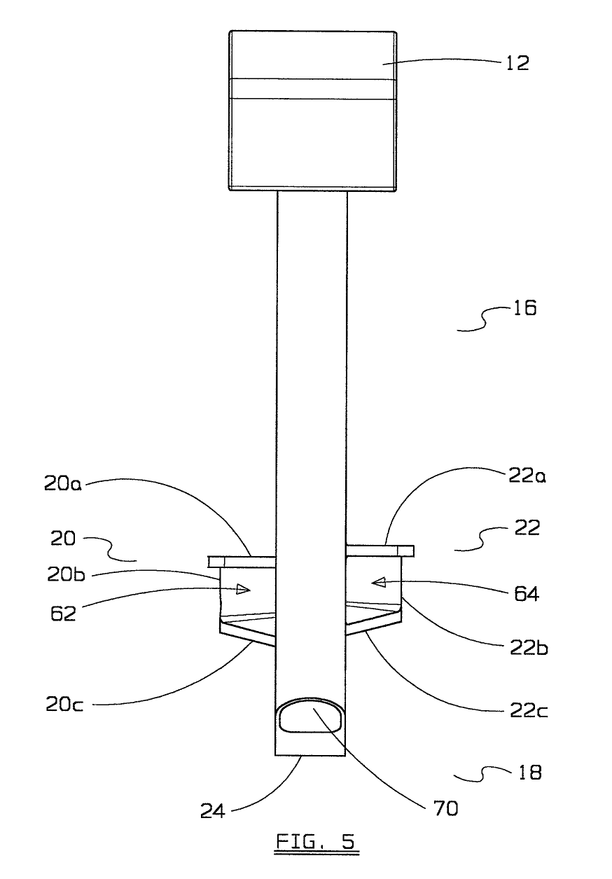

As also seen in FIGS. 2-5, mounting block 12 and blade 14, including trunk 16 and foot 18, are elongate in a generally vertical first plane A. The first plane includes longitudinal axis A′. With the exception of wings 20 and 22 and canards 21, as better described below, the outer surface of trunk 16 smoothly merges into, so as to truncate in cross-section as, a waisted or i15 foot-shaped lower surface 24. In one embodiment access panels 26 and 28, which conformally mount onto the lateral side walls of trunk 16, are symmetrically shaped relative to the plane of symmetry of trunk 16. The plane of symmetry of trunk 16 coincides with the first plane.

Upper ported mounting block 12 and mounting can 12′ have ports 30, 32 and 34 formed in their upper surfaces. The ports extend downwardly through block 12 in cooperative alignment with corresponding channels 36, 38 and 40 extending downwardly in generally parallel spaced apart array through trunk 16. Channel 40 also extends downwardly through foot 18.

Channels 36 and 38 may, in one preferred embodiment not intended to be limiting, be formed by the alignment and snug adjacency of flanges 42 and 44 on the inner sides of access panels 26 and 28 respectively when the access panels are mounted conformally in opposed relation, to the lateral sides of trunk 16 so as to cover cavity 46 in trunk 16. Access panel 26 may be mounted onto the port side of trunk 16 by means of tab 48 slidably engaging corresponding slot 50, formed in the lower surface defining cavity 46, so as to protrude downwardly into foot 18. In a similar fashion, tab 52 on access panel 28 also slidably engages slot 50 when mounting access panel 28 onto the starboard side of trunk 16. The upper ends of access panels 26 and 28 may be secured by releasable fasteners, for example a cooperating, flush-mounted nut and bolt pair (not shown) journalled through apertures 56.

With access panels 26 and 28 mounted onto trunk 16, so as to cooperatively align and abut flanges 42 and 44, thereby completing forming and separation of channels 36 and 38, channels 36 and 38 form a pair of chutes in cooperative alignment between ports 30 and 32 in mounting block 12 and corresponding lower outlet ports 58 and 60. Lower outlet ports 58 and 60 are directed laterally oppositely and open into the respective interior ducts 62 and 64 formed within respective wings 20 and 22. Interior ducts 62 and 64 open out into corresponding aft-facing apertures from under their respective wings 20 and 22 as better hereinafter described.

Toe 66, which may be of a different and hardened material relative to the material forming mounting block 12, trunk 16 and foot 18, is rigidly mounted, by bolting or other means known in the an, to the forward portion of foot 18 so as to form a forwardly extending point or snout 68, forwardly facing in the direction of forward translation B when the blade is translated in use. Advantageously, mounting block 12, trunk 16 and foot 18 may be made of austempered ductile iron (hereinafter ADI) and toe 66 nay be made of a chrome alloy. Access panels 26 and 28 and wings 20 and 22 may also be made of ADI.

Channel 40 is formed within and along the rear or aft edge of trunk 16 and foot 18 so as to form a continuous generally linear conduit between port 34 and rear aperture 70. Advantageously, the rear-most end of foot lower surface 24 is upturned for example as to provide aperture 70 with an opening generally perpendicular to the longitudinal axis of channel 40. Further advantageously, channels 36, 38 and 40 are generally parallel so as to be raked aft in a downward direction from ports 30, 32 and 34.

Wings 20 and 22 are each shaped as truncated wedges or otherwise as what may be described as irregular pyramid shapes wherein the vertex of each wedge or pyramid is aligned so as to be forward facing (in direction B) with the wedge diverging aft so as to form correspondingly shaped interior ducts 62 and 64 opening aft through the base of the wedges. In one preferred embodiment, the acute angles alpha (α) and beta (β), formed at the vertex of the wedges forming wings 20 and 22, are each approximately 5 degrees. In the preferred embodiment upper surfaces 20a and 22a, lateral surfaces 20b and 22b, and lower surfaces 20c and 22c of wings 20 and 22 respectively are each generally planar. In one embodiment such as seen in FIG. 3a, upper surfaces 20a and 22a are inclined forwardly further downwardly relative to the plane containing foot lower surface 24, thus a plane H bisecting angle β would in this embodiment advantageously form an angle of approximately 5° relative to the plane F containing lower foot surface 24.

Upper surfaces 20a and 22a extend aft and are cantilevered outwardly over the aft apertures of interior ducts 62 and 64. The aft apertures of interior ducts 62 and 64 are advantageously formed by reducing the longitudinal length of lateral side walls 20b and 22b and raking the rearmost edge of lower surfaces 20c and 22c so as to extend them contiguously aft from the rear edge of lateral side walls 20b and 22b respectively to blend with foot 18.

In the preferred embodiment, foot 18 is curvaceously waisted along its longitudinal length so as to form between curved side walls a forward expanded lateral dimension 72 smoothly tapering into a reduced lateral dimension 74 corresponding to the waisting and, progressing aft, a gentle flaring to an aft expanded lateral dimension 76. In the preferred embodiment the waist of foot 18 approximately corresponds, in the longitudinal direction of axis A′, to the position of the forward ends of wings 20 and 22. As seen in FIG. 3b, the lower surface 24 maybe concave or upwardly scalloped and the removable tip may include a pair of canards 21 disposed oppositely on either side of the tip. Mounting ears 12′ may include horizontal flanges or ridges 12a′ which allow the blade to be mounted slightly higher or lower relative to the coulter wheel described below.

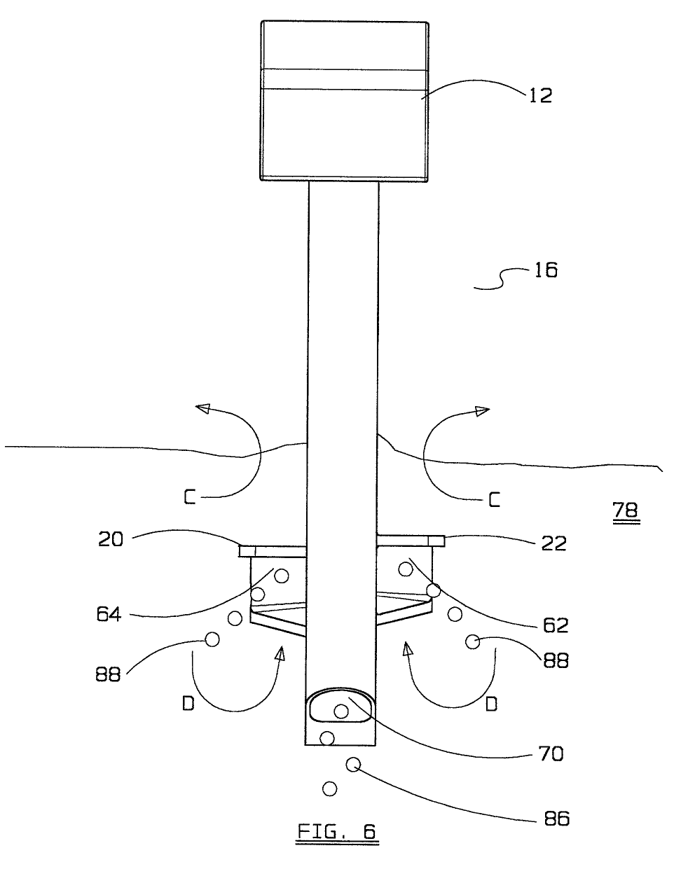

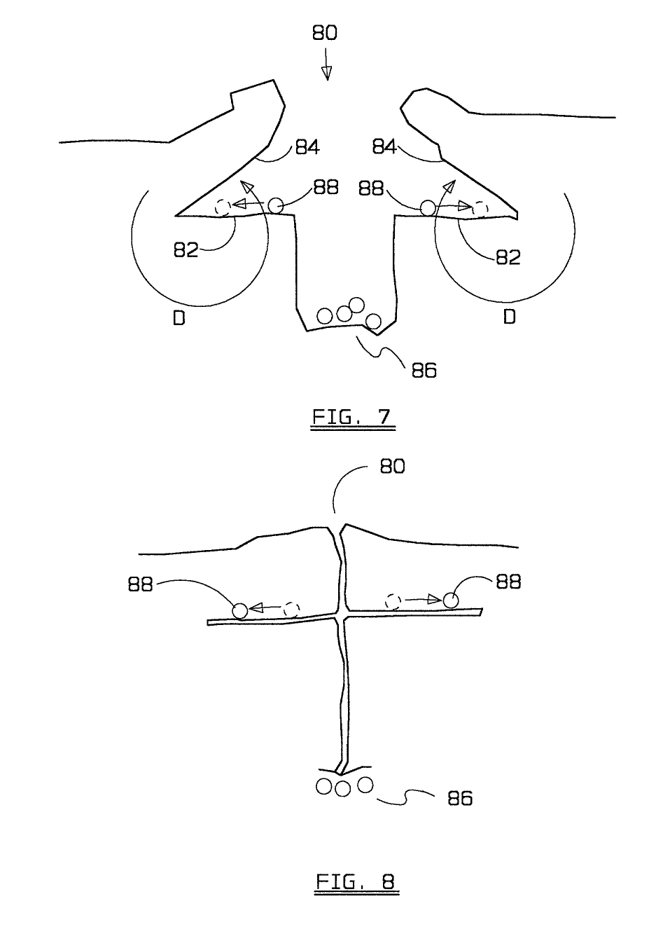

In use, blade 16 is translated in direction B through soil 78. As seen in FIG. 6, blade 16 is driven forwardly and positioned as better hereinafter described so as to maintain wings 20 and 22 submerged at a shallow depth below the surface of soil 78. Such motion opens the soil upwardly from point 68 on toe 66 upwardly along the leading edge of foot 18 and blade 16 causing a small lifting and separating of soil 78 in opposite directions C. As blade 16 translates through the soil, material fed into ports 30, 32 and 34 flows under the force of gravity through respective channels 36, 38 and 40. Material flowing through channel 40 exits tough aperture 70 at the lowermost position of the narrow furrow 80 seen in FIG. 7 formed in soil 78 by the passing of blade 14 therethrough. The passing of wings 20 and 22 through soil 78 form shelves 82 in the soil as the soil is displaced by the wings so as to form shoulders 84 approximated in the illustration of FIG. 7.

The forward movement in direction B of blade 14 through soil 78 draws material such as fertilizer 86 from aperture 70, and also draws material such as seeds 88 from ducts 62 and 64 as the seeds are fed from channels 36 and 38 through outlet ports 58 and 60 respectively.

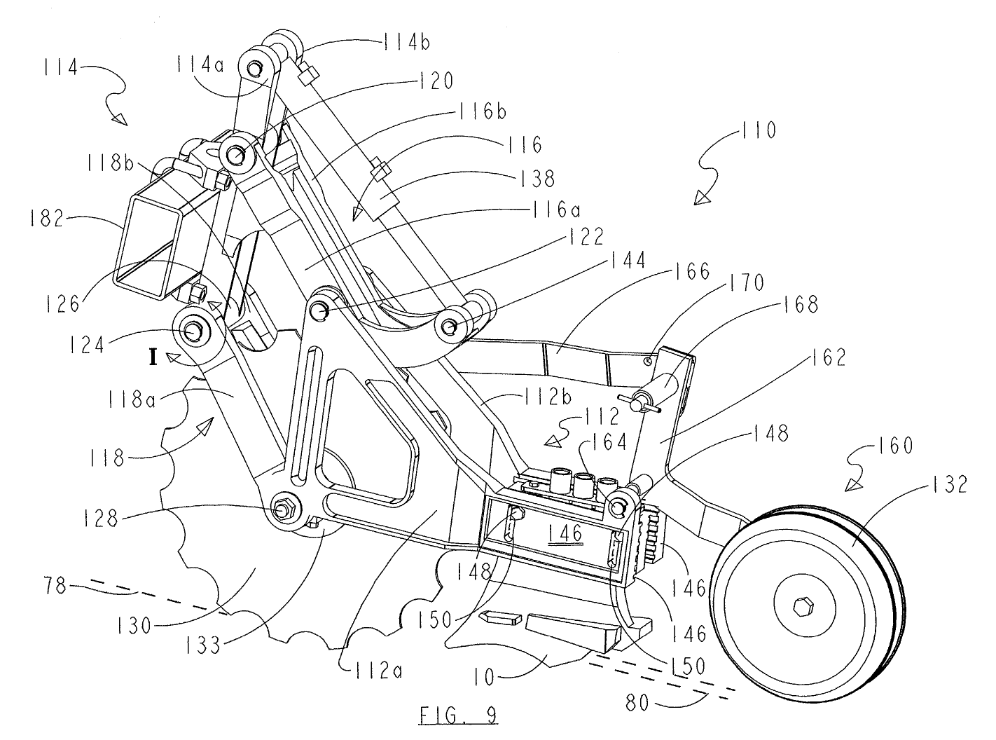

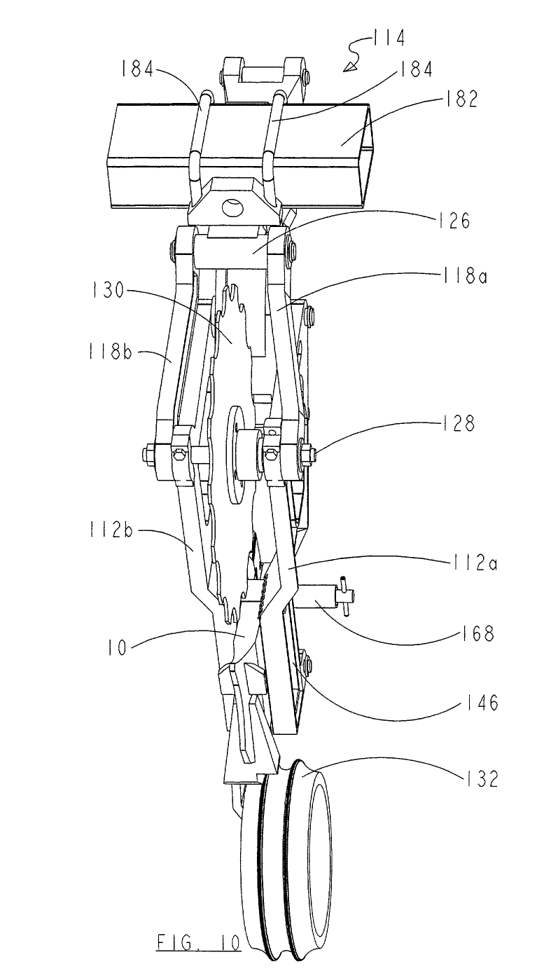

It has been found that the passing of wings 20 and 22, and in the embodiment of FIG. 3b ands 21, and the passing of foot i8 in their form as described herein, muses a fluid-like circulation in direction D of soil 78 aft of wings 20 and 22. It is understood that the view of FIG. 7 is an approximation of the cross-section through the soil immediately behind blade 14 as it is translating trough the soil. The soil, acting in a fluid manner, collapses so as to drop down shoulders 84 as the soil beneath shelves 82 is circulated in counter-rotation in direction D. Applicant has found that this circulation transports seeds 88 laterally outwardly along shelves 82 so as to facilitate advantageous lateral spacing apart of seeds on either side of furrow 80 separated both laterally and vertically from fertilizer 86 so as to inhibit chemical burning of the seeds for example by reason of the spacial relationship approximated by the illustration of FIG. 8.

It is understood that the order and type of materials introduced into ports 30, 32 and 34 may be changed as would be known to one skilled in the art so as to introduce, for example, seeds through ports 30 and 32 and water through port 34. A person skilled in the art would also understand that ports 30, 32 and 34 would have to be attached by appropriate conduits to corresponding hoppers or reservoirs carried, for example on a tractor (not shown) or trailer.

In the preferred embodiment, although not intended to be limiting, certain planes assist in defining the relationship of the elements of the present invention relative to one another as described above and claimed hereinbelow. Firstly, blade structure 14 is generally bisected by a first plane A, referred to above as coinciding with the plane of symmetry of trunk 16, which contains both the axis A′ and the cross-sectional view reference line 2-2 seen in FIG. 1. The cross-sectional view of FIG. 2 is a view through a cutaway along first plane A. A second plane E is the plane containing the edges of aperture 70 at the lowermost end of channel 40. A third plane F is the plane containing foot lower surface 24. A fourth plane G is the plane containing the upper surface of mounting block 12. Lastly, a wing bisecting plane H bisects wing 20 by bisecting angle beta. A corresponding parallel wing bisecting plane bisects wing 22 by bisecting the corresponding angle on wing 22.

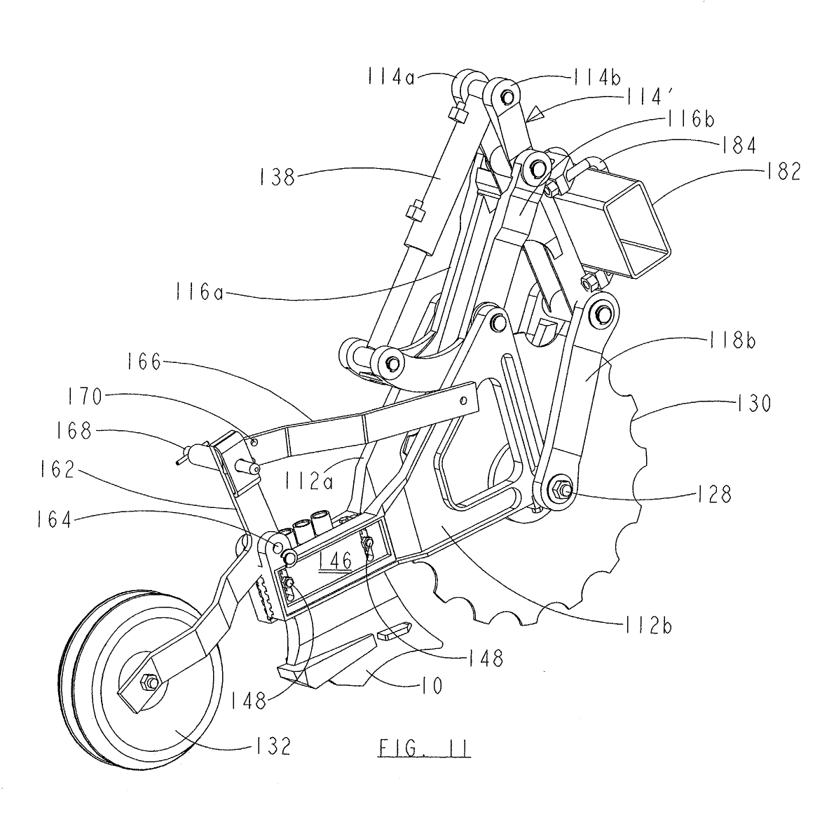

As seen in FIGS. 9-13, blade 10 is mounted to an actuating linkage 110 whereby the blade may be lowered into the soil 78 or elevated out of contact with soil 78.

Actuating linkage 110 is a parallelogram linkage for displacement in direction I of header assembly 112, specifically members 112a and 112b relative to hanger apparatus 114. The members are pivoted relative to hanger apparatus 114 on pivotally mounted upper drag arms 116 and lower drag arts 118. Each opposite end of the upper and lower drag arms are pivotally mounted by means of pins, bolts or the like. Thus upper drag arms 116 are mounted at one end to members 114a and 114b of hanger apparatus 114 by means of pin 120. The opposite end of upper drag arms 116, which include parallel arms 116a and 116b, are mounted between the upper ends of side plates 112a and 112b by means of pin 122.

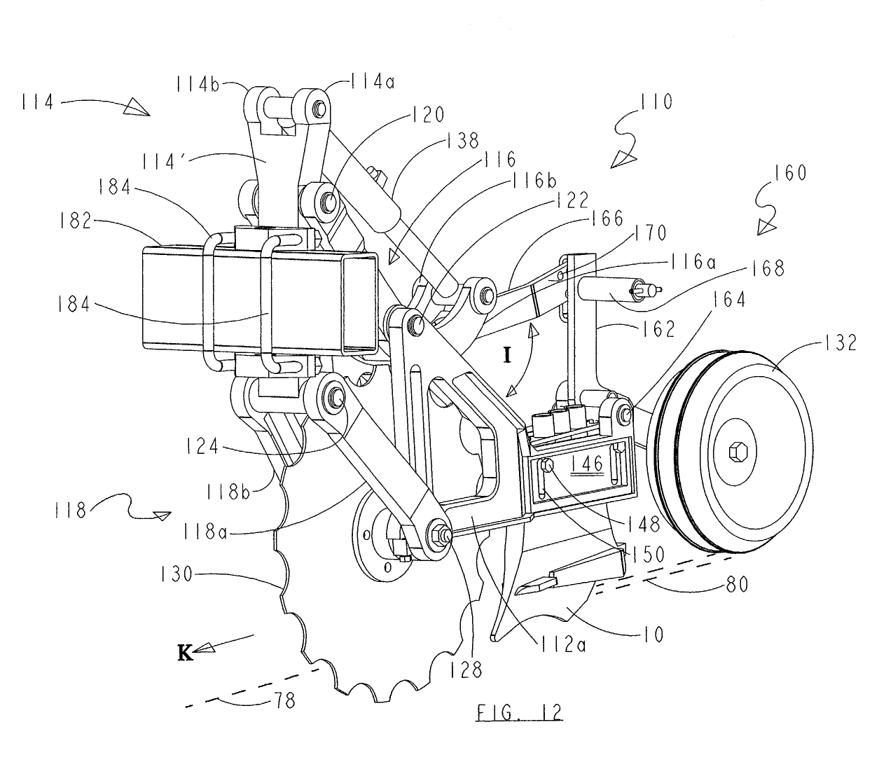

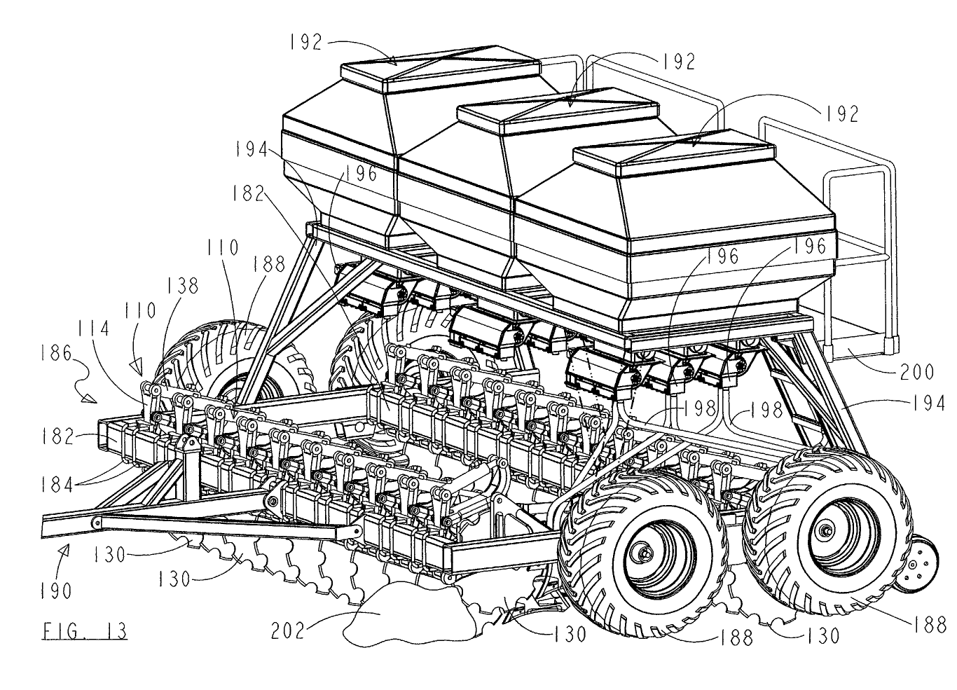

Lower drag arms 118 include an opposed pair of parallel rigid arms 118a and 118b each pinned at the corresponding lower ends of hanger members 114a and 114b by means of a pin 124. As better seen in FIG. 11, as 118a and 118b of lower drag arm 118 are coupled to each other by collar 126 as seen in FIG. 10. The opposite end of lower drag arms 118 are pivotally mounted to header members 112 by means of shaft 128.

Coulter wheel 130 is rotatably mounted on shaft 128, so as to sandwich the lower forward corners of header members 112a and 112b by means of a pair of mounting plates 133.

Consequently, the coulter wheel is not fire to swivel relative to blade 10, but rather is held aligned, generally co-planar, with the blade.

The parallelogram linkage of upper drag arms 116 and lower drag arms 118 and header members 112 are actuated so as to rotate in direction I about hanger apparatus 114 by, in one embodiment, selective actuation of hydraulic ram 138. Hydraulic ram 138 is fed by high pressure hydraulic lines (not shown) as would be known by one skilled in the art. The upper end of hydraulic ram 138 is rigidly mounted to hanger apparatus 114, specifically, between the upper ends of hanger members 114a and 114b. The lower end of hydraulic ram 138 is pivotally between upturned lower ends of upper drag arms 116 by means of pinned coupling 144. Extension of hydraulic ram 138 causes rotation of the upper and lower drag arms downwardly, about pins 120 and 124, relative to hanger apparatus 114. Retracting so as to shorten hydraulic ram 138 rotates the upper and lower drag arms upwardly. Thus with blade 10 mounted by means of mounting block 12 or mounting ears 121 between the lower rear ends of header members 112a and 112b, the lower end of blade 10 may be selectively depressed below the surface of soil 78 so that blade 10 follows inline with the ground breaking engagement of coulter wheel 130 with the soil. In the embodiment of FIGS. 9-15 employing the blade of FIG. 3b, flanges 12a′ interlock with corrugations, grooves or channels 146a on the interior surfaces of the side plates 146 of the header assembly 112. Side plates 146 are clamped together so as to sandwich flanges 112a′ and the upper end of blade 10 by means of bolts 148. Bolts 148 extend through elongate apertures 150 in side plates 146 and bolt holes 152 in the upper end of blade 10. Apertures 150 are vertically elongate so that the vertical position of blade 10 relative to side plates 146 may be adjusted, for example to compensate for erosive wear of coulter wheel 130.

As blade 10 is dragged in direction B through soil 78 a furrow 80 is created as described above. In one embodiment of the present system, a closure assembly 160 is mounted between header members 112a and 112b. L-shaped arm 162 has its elbow pivotally mounted on pin 164 at the upper rear end of side plates 146, between members 112a and 112b. A closing wheel 132, or pair or plurality of such wheels are rotatably mounted to the lower rearward end of arm 162 so as to press down into engagement with the upper surface of furrow 80 formed behind blade 10 as blade 10 passes through soil 78. Downwards pressure is applied to wheel 132 by the force of actuator 138 and/or the weight of linkage assembly 110 and blade 10. Arm 162 is maintained in its angular position about pin 164 by means of arm 166, better seen in FIG. 11, mounted to header member 112b.

Arms 162 and 166 may be releasably pinned together by a manually releasable pin 168. Pin 168 may be removed to allow angular adjustment between arms 162 and 166, pin 168 being selectively insertable into an array of holes 170 along the rear end of aim 166. Selectively positioning the upper end of arm 162 outwardly along arm 166 rotates wheel 132 downwardly relative to header assembly 112 about pinned shaft 164 so as to selectively and adjustably apply a downward pressure against the upper surface of furrow 80.

As better seen in FIG. 12, each of hanger members 114a and 114b making up hanger apparatus 114 may in fact each be parallel lobes of a rigid yoke in the upper end of a single rigid member 114 by u-shaped brackets 184.

In one preferred embodiment, such as seen in FIG. 13, bar 182 extends laterally across a supporting frame structure 186 so that a laterally spaced apart array of actuating linkages 110 may be mounted across one or more spaced apart bars 182. The supporting frame structure 186 supporting bars 182 is preferably mounted on wheels 188 so that the entire structure may be towed by a tow coupling 190 or otherwise mounted to a tractor (not shown) or the like thereby simultaneously pulling a laterally spaced apart array of blades 10 through soil 78.

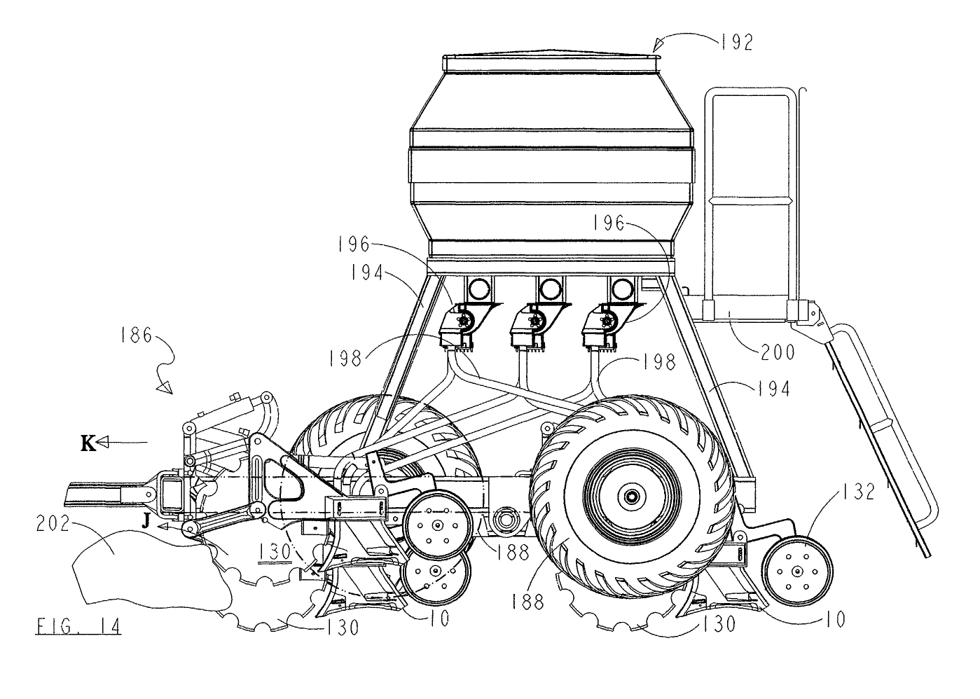

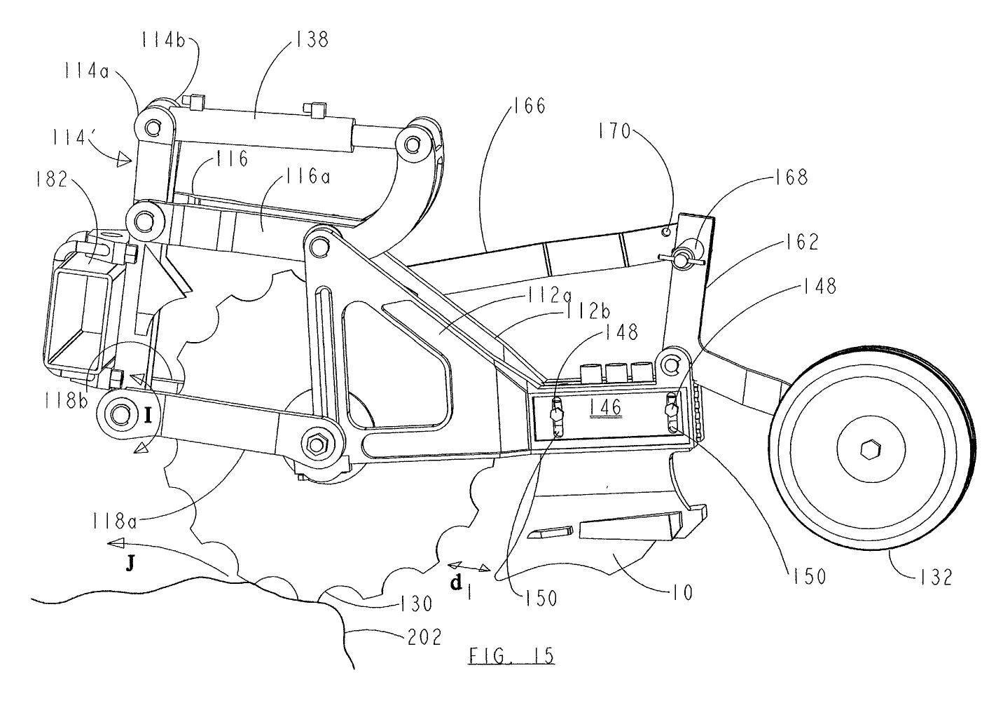

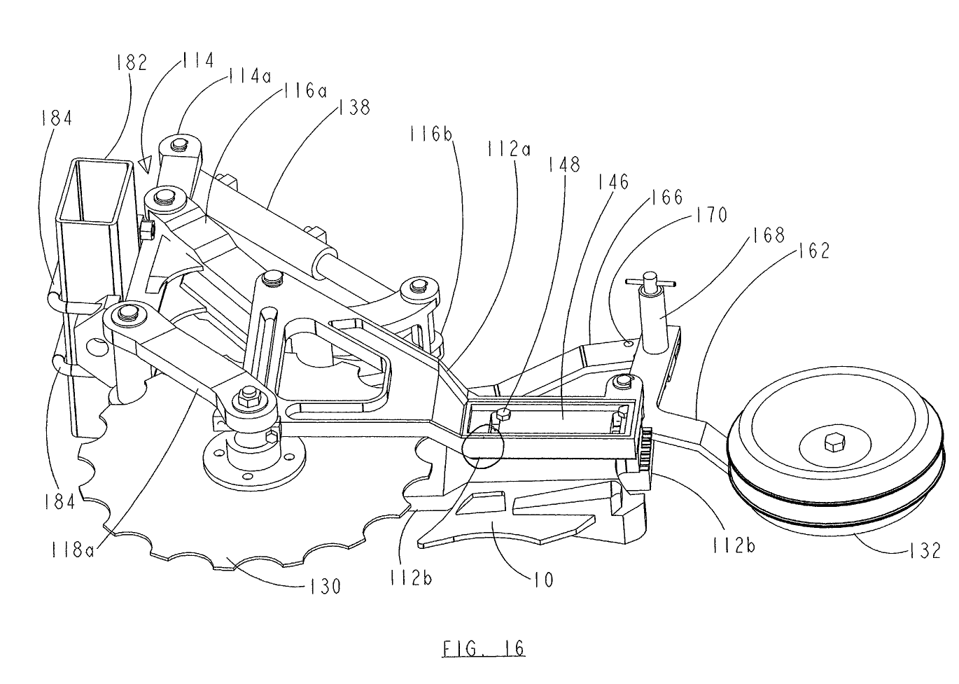

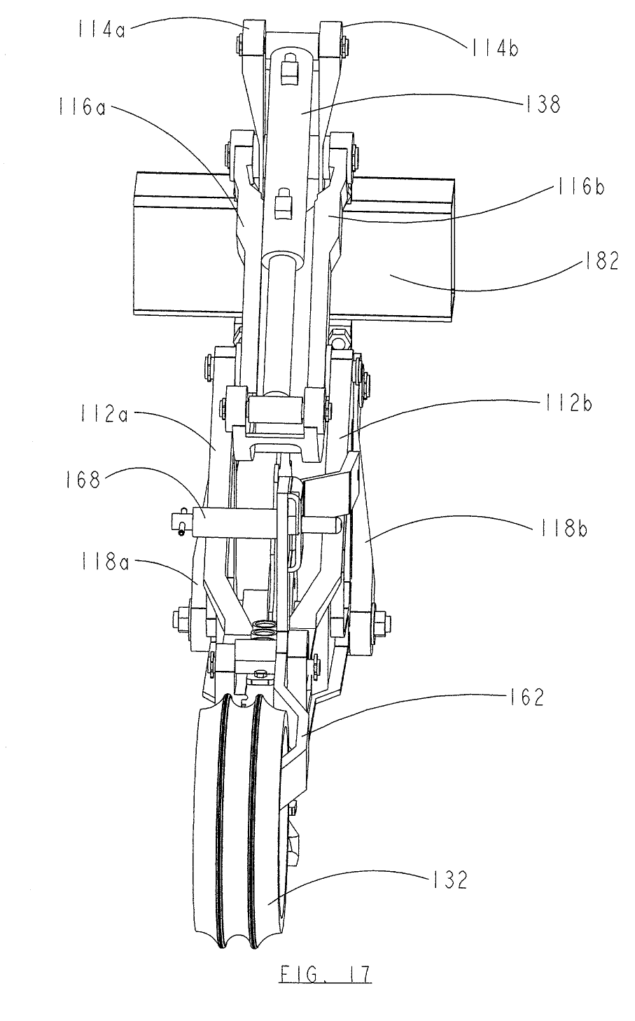

Thus as also seen in FIG. 14, the supporting frame structure 186 may also be used to support hoppers 192 on supporting legs 194. Hoppers 192 supply granular material such as seed or fertilizer to metering devices 196 mounted beneath the hoppers so as to feed, via conduits 198 such granular material into blade apertures 30, 32 and 34 forming the infeed inlets into blades 10. In FIG. 13, conduits 198 are omitted, with the exception of those extending from the metering devices 196 most closely in the foreground in order to maintain a clear view of the arrays of linkages 110 mounted to the parallel laterally extending bars 182. As may be seen, a work platform 200 and an associated ladder may also be mounted to legs 194 so as to provide ease of access to for example hoppers 192.

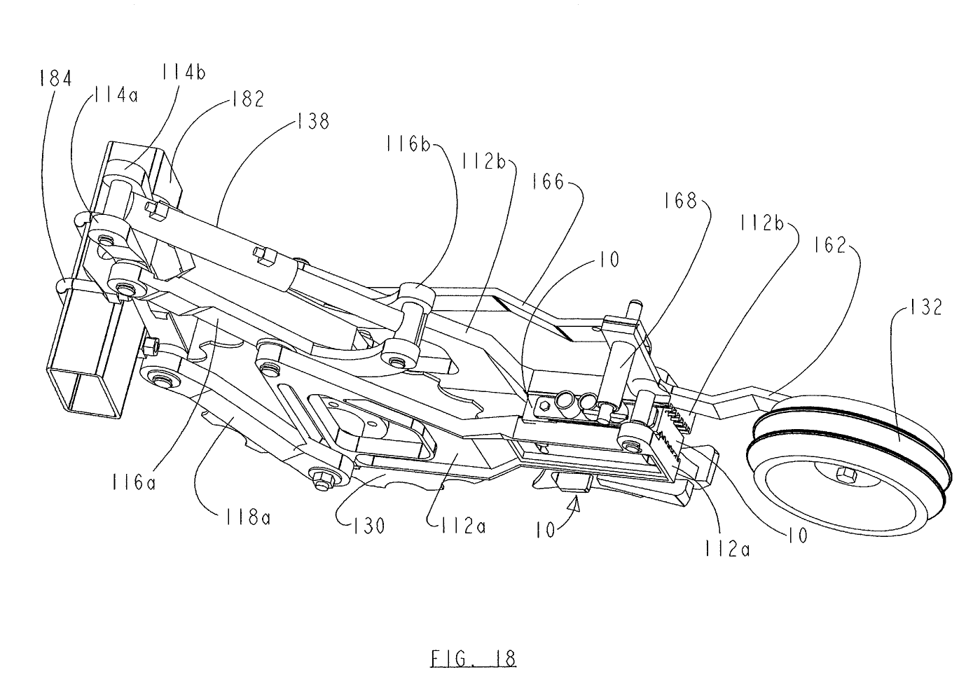

One advantage of the inline arrangement of coulter wheels 130 and corresponding blades 10 is also illustrated in FIGS. 13 and 14. In, particular, the leading edge of blades 10 are, as so seen in FIGS. 15 and 16, mounted adjacent to the outer circumference of the coulter wheel. As used herein, the term adjacent in describing the spatial relationship between coulter wheel 130 and blade 10 means that the distance d1 between the outer circumference of coulter wheel 130 and the point of the toe on the leading edge of blade 10 is sufficiently narrow so that large rocks or boulders will not become jammed therebetween. With coulter wheel 130 mounted so as to rigidly maintain its inline alignment with blade 10, rather than a large rock or boulder impacting the leading edge of blade 10, the coulter wheel impacts the boulder such as the illustrated boulder 202 and rides up and over the boulder in direction J as the coulter wheel rotates in engagement with the ground. Because both coulter wheel 130 and blade 10 are mounted to header assembly 112, as coulter wheel rides up and over boulder 202 in direction J, the entire linkage 110 pivots upwardly, and because of the parallelogram formed by the upper and lower drag arms, blade 10 is not only elevated simultaneously with coulter wheel 130 but maintains its angular orientation relative to the ground as the entire fame structure 186 is translated forwardly in direction K on wheels 188. Thus as fame structure 186 is treated across a field, at any one time one or more of the coulter wheels 130 may encounter large rocks or boulders. This will not impede the progress of the frame structure and its associated arrays of coulter wheels and blades as only those coulter wheels and blades which encounter obstacles such as large rocks or boulders or the like will ride up over the obstacles and once pass the obstacles will once again lower into position at the optimal depth for seeding and fertilizing. Consequently it may be seen the advantage of having laterally extending arrays of linkages 110, one for each set of inline coulter wheels and blades. The use of two tiers of laterally extending arrays of linkages 110 allows for increased seeding density laterally across the width of the supporting frame, that is, an increased number of seeding rows or furrows formed across the width of the frame structure notwithstanding the physical width requirements of each linkage 110 and their associated coulter wheels, blades, closing wheels and feed conduits.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An in-line sub-surface seeding, fertilizing and watering device comprising an in-line blade mountable into a header means parallelogram linkage so as to be vertically downwardly disposed generally in a plane containing said linkage, said blade having internal conduits for transporting seed, fertilizer or water from an upper infeed to openings at a lower end of said blade, said parallelogram linkage comprising a pair of parallel rigid drag arms extending between said header means and a hanger means, said arms pinned at their respective ends to said header means and said hanger means so that rotation of said header means relative to said hanger means on said parallel arms maintains a generally horizontal orientation of said header means thereby supporting said blade, when mounted in said header means, downwardly in a constant orientation, wherein said hanger means is mountable to a supporting frame, said device further comprising selective actuation means for selective control of a downward force urging said blade, when mounted on said header means, downwardly into soil, a coulter wheel mounted to said linkage forward of, so as to be adjacent to said blade for simultaneous elevation and lowering of said wheel and said blade on said linkage, said wheel and said blade generally co-planar.

2. The device of claim 1 wherein said selective actuation means is a hydraulic actuator mounted between said hanger means and said drag arms, whereby said wheel and said blade may also be selectively elevated so as to remove said wheel and said blade from the soil.

3. The device of claim 1 wherein said selective actuation means is a hydraulic actuator mounted between said frame and said header means, whereby said wheel and said blade may also be selectively elevated so as to remove said wheel and said blade from the soil.

4. The device of claim 1 wherein said selective actuation means is a hydraulic actuator mounted between said hanger means and said header means, whereby said wheel and said blade may also be selectively elevated so as to remove said wheel and said blade from the soil.

5. The device of claim 1 wherein said selective actuation means is a hydraulic actuator mounted between said frame and said drag arms, whereby said blade may also be selectively elevated so as to remove said blade from the soil.

6. The device of claim 1 wherein said wheel and said blade are co-planar in a vertical plane.

7. The device of claim 1 further comprising a furrow closing means mounted to a rear end of said header means so as to trail rearwardly therefrom in line with a furrow created by said wheel ad said blade passing through the soil.

8. The device of claim 7 wherein said closing means is a closing wheel urged downwardly by a selectively adjustable downward biasing means mounted to a rear end of the header means.
